(19) United States
(12) Patent Application Publication
(10) Pub. No.: US 2005/0243547 A1
(43) Pub. Date: Nov. 3, 2005

(54) Light mounting fixture for intersecting surfaces of variable length and method for installing same

(76) Inventors: Sam Cini, Brampton (CA); Len Black, Mississauga (CA)

Correspondence Address: PEARNE & GORDON LLP, 1801 EAST 9TH STREET, SUITE 1200, CLEVELAND, OH, 44114-3108, US

(21) Appl. No.: 10/833,434

(22) Filed: Apr. 28, 2004

(51) Int. Cl. F21S 4/00

(52) U.S. Cl. 362/219; 362/217; 362/222; 362/224; 362/225; 362/260

(57) ABSTRACT

In one inventive aspect, a light mounting fixture for first and second surfaces that intersect at a corner, and an associated installation method. A plurality of attachment devices is for connection to the two surfaces. First and second cove pieces are for connection to respective groups of the attachment devices, for extending along the first and second surfaces, respectively, and for receiving at least one lighting device, respectively. The first and second cove pieces each have ends for location in the vicinity of intersection of the surfaces at the corner, with the ends being located in a non-fitted manner with respect to at least one of the surfaces or each other. A corner piece overlaps at least a portion of each of the first and second cove pieces and obscures from view the ends of the first and second cove pieces and the non-fitted manner of location of the ends.

### FIELD OF THE INVENTION

The present invention is directed in general to light mounting fixtures that extend along intersecting surfaces, and is particularly directed to light mounting fixtures that are capable of being expeditiously sized on-site to fit the area of installation.

### BACKGROUND OF THE INVENTION

Linear light fixtures are often installed along surfaces, such as interior or exterior walls of a building structure. Such fixtures may be located at any height on such walls, but are often located at or near an upper extent the wall. Often, the fixtures include structure behind which lighting devices are located. Thus, the overall exterior appearance is very aesthetically pleasing.

Often, it is desirable to have a light fixture extend along an entire extent of a surface (e.g., a building wall). Also, it is often desirable for the light fixture to extend along two intersecting surfaces (e.g., two walls intersecting at a corner). Typically, the extent along which the light fixture is to run is subject to variation. In general, each application of a light fixture will involve a different extent dimension. As such, light fixtures must be sized for each measured extent dimension. Such sizing, is time and labor intensive, subject to error and the generation of miss-sized pieces, and other undesirable effects. Often, the sizing must be done at an off-site manufacturing facility.

Also, in a typical installation of known linear light fixtures, the fixtures are sequentially installed beginning from a predetermined starting point. By commencing installation of linear light fixtures at a convenient starting point, several linear light fixtures may be mounted to span at least a majority of the area receiving the lights. However, because the overall length or width of the area receiving the lights is rarely an integer multiple of a single linear light fixture, there is typically a remainder length of the area where a standard-length linear light fixture is not installed. Shadows and dark areas may exist beneath the remaining length where uniform illumination is not adequately provided by the standard-length linear light fixtures.

Methods of installing light fixtures have also been developed to eliminate non-uniform illumination. An example of such a method is the custom fabrication and installation of lighting fixtures according to the particular dimensions on a case-by-case basis. According to this method, the exact dimensions of the area of installation must be measured, typically by a professional installation technician. The measurements must be exact, and must be accurately transmitted to a manufacturing facility where the fixtures are assembled according to the measurements. Custom installation of light fixtures is time consuming considering that the light fixtures cannot be fit and assembled on a site. Furthermore, the method of custom installing light fixtures includes several opportunities for the introduction of errors into the method, errors that would lead to large amounts of waste. An erroneously manufactured light fixture must be replaced by a replacement light fixture that must also be fabricated. The erroneously manufactured light fixture is then discarded unless another area of installation requires a light fixture with those same dimensions, which is highly unlikely. And finally, the cost of materials and labor for custom installation of light fixtures often exceeds the benefits derived there from.

### SUMMARY OF THE INVENTION

In accordance with one aspect, the present invention provides a light mounting fixture for first and second surfaces that intersect at a corner. The light mounting fixture includes a plurality of attachment devices for connection to the two surfaces. A first cove piece of the fixture is for connection to a first group of the attachment devices, for extending along a segment of the first surface, and for receiving at least one lighting device therein. A second cove piece of the fixture is for connection to a second group of the attachment devices, for extending along a segment of the second surface, and for receiving at least one lighting device therein. The first and second cove pieces each have ends for location in the vicinity of intersection of the surfaces at the corner, with the ends being located in a non-fitted manner with respect to at least one of the surfaces or each other. A corner piece of the fixture overlaps at least a portion of each of the first and second cove pieces and obscures from view the ends of the first and second cove pieces and the non-fitted manner of location of the ends.

In accordance with another aspect, the present invention provides a light mounting fixture for first and second surfaces that intersect at a corner. The light mounting fixture includes a plurality of attachment devices for connection to the two surfaces. A first cove piece of the fixture is for connection to a first group of the attachment devices, for extending along a segment of the first surface, and for receiving at least one lighting device therein. A second cove piece of the fixture is for connection to a second group of the attachment devices, for extending along a segment of the second surface, and for receiving at least one lighting device therein. The first and second cove pieces each have ends for location in the vicinity of intersection of the surfaces at the corner with at least one of the ends of the first and second cove pieces being spaced away from the surface associated with the other of the first and second cove pieces or being spaced away from the other of the first and second cove pieces. A corner piece of the fixture is for overlapping a least a portion of each of the first and second cove pieces and for obscuring from view the ends of the first and second cove pieces and any spacing of the ends away from the surfaces and each other.

In accordance with yet another aspect, the present invention also provides a light mounting fixture that includes means for attaching the fixture to a surface, a cove piece for connection to the means for attaching and extending along a segment of the surface, and a lighting device received within the cove piece. The lighting device includes a lamp and at least one sliding lamp socket for receiving an end of the lamp.

In accordance with yet another aspect, the present invention also provides a method of installing a light mounting fixture on first and second surfaces that intersect at a corner. A plurality of attachment devices is connected to the two surfaces. A first cove piece, which receives at least one lighting device therein, is connected to a first group of the attachment devices such that the first cove piece extends along a segment of the first surface. A second cove piece, which receives at least one lighting device therein, is connected to a second group of the attachment devices such that the second cove piece extends along a segment of the second surface. The steps of connecting the first and second cove pieces include positioning at least one of the first and second cove pieces such that at least one of the ends of the first and second pieces, which are in the vicinity of intersection of the surfaces at the corner, are located in a non-fitted manner with respect to at least one of the surfaces or each other. A corner piece is overlapped over at least a portion of each of the first and second cove pieces to obscure from view the ends of the first and second cove pieces and the non-fitted manner of location of the ends.

### BRIEF DESCRIPTION OF THE DRAWINGS

The foregoing and other features and advantages of the present invention will become apparent to those skilled in the art to which the present invention relates upon reading the following description with reference to the accompanying drawing, in which:

FIG. 1 is a partially broken-away, perspective view from above of an example of a light mounting fixture in accordance with the present invention installed on two intersecting surfaces and with associated lights installed therein;

FIG. 2 is a top view of the light mounting fixture of FIG. 1 and shows an example of a spacing relationship between the components of the fixture and the surfaces;

FIG. 3 is a perspective view from below of example attachment devices of light mounting fixture of FIG. 1 on a respective one of the surfaces;

FIG. 4 is a perspective view from below of the attachment devices of FIG. 3 and with an example light fixture supported thereon;

FIG. 5 is a perspective view from above of the light fixture of FIG. 4 and shows the adjustability of the light fixture;

FIG. 6 is a perspective view from below of the completed light mounting fixture;

FIG. 7 is a view similar to FIG. 6 but shows another example of a light mounting fixture having a different appearance; and

FIGS. 8-11 show different example profiles that may be used within varying embodiments of the light mounting fixture in accordance with the present invention;

FIG. 12 is an upwardly looking perspective view of another example of a light mounting fixture, which extends around exterior corners of an island located on a ceiling;

FIG. 13 is a perspective view from above of another example light fixture;

FIG. 14 is a perspective view from above of yet another example light fixture;

FIG. 15 is a perspective view showing details of still another example light fixture;

FIG. 16 is a perspective view from above of still another example light fixture;

FIG. 17 is a perspective view from above of yet still another example light fixture; and

FIG. 18 is a perspective view showing details of still further another example light fixture.

### DETAILED DESCRIPTION OF EXAMPLE EMBODIMENTS

Certain terminology is used herein for convenience only and is not to be taken as a limitation on the present invention. Further, in the drawings, the same reference numerals are employed for designating the same elements, and in order to clearly and concisely illustrate the present invention, certain features may be shown in somewhat schematic form.

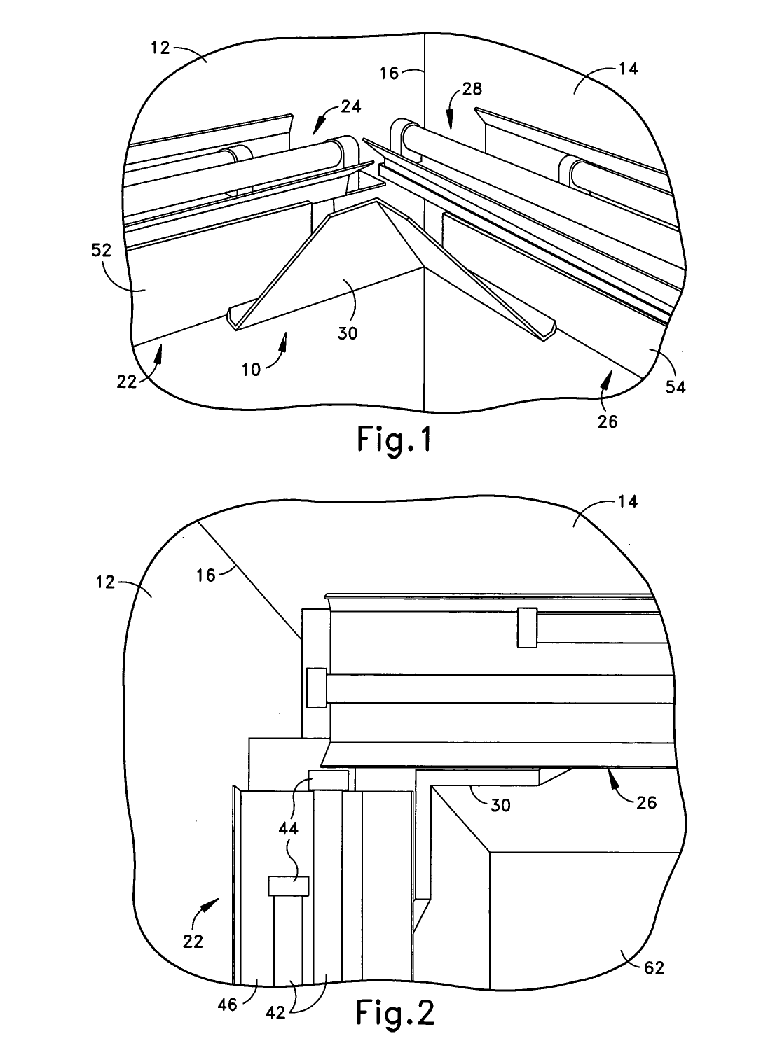

An example of a light mounting fixture 10 in accordance with the present invention is shown in FIG. 1. The light mounting fixture 10 is located on two surfaces 12 and 14 that intersect at a corner 16. In the example, the surfaces 12 and 14 are wall surfaces, however, it is to be appreciated that the surfaces may be something other than wall surfaces. Also, it is noted that the shown example of FIG. 1 is for an intersection that is an interior corner 16. It is to be appreciated that the present invention is applicable to surfaces that intersect at an exterior corner.

As can be appreciated upon viewing FIGS. 1 and 2, the light mounting fixture 10 includes a first segment 22 that extends along a segment of the first surface 12 and that has a first light device 24 associated therewith, a second segment 26 that extends along a segment of the second surface 14 and that has a second light device 28 associated therewith, and a corner piece 30 that overlaps at least a portion of each of the first and second segments. It is to be noted that neither of the segments (e.g., 22) needs to extend to engage the surface (e.g., 14) associated with the other segment (e.g., 26). In other words, at least one and possibly both of the ends of the segments 22 and 26 are spaced from the opposing surface 12 and 14. Although it is possible that one of the segments (e.g., 26) engages the opposed surface (e.g., 12). Also, it is to be noted that the segments 22 and 26 need not engage each other. In other words, a space exists between the segments 22 and 26. However, it is possible that the segments engage.

The possible spacing(s) (e.g., between each other and/or the surfaces) is referred to herein as a non-fitted manner. The corner piece 30 is configured to overlap the ends of the first and second segments 22 and 26 and obscure from view the ends of the first and second segments and any spacing of the ends from the surfaces 12 and 14 and each other. In other words, the corner 30 covers over the non-fitting manner of the first and second segments 22 and 26. Along these lines, the corner piece 30 of the fixture overlaps at least a portion of each of first and second cove pieces, to be discussed below, and obscures from view the ends of the first and second cove pieces and the non-fitted manner of location of the ends.

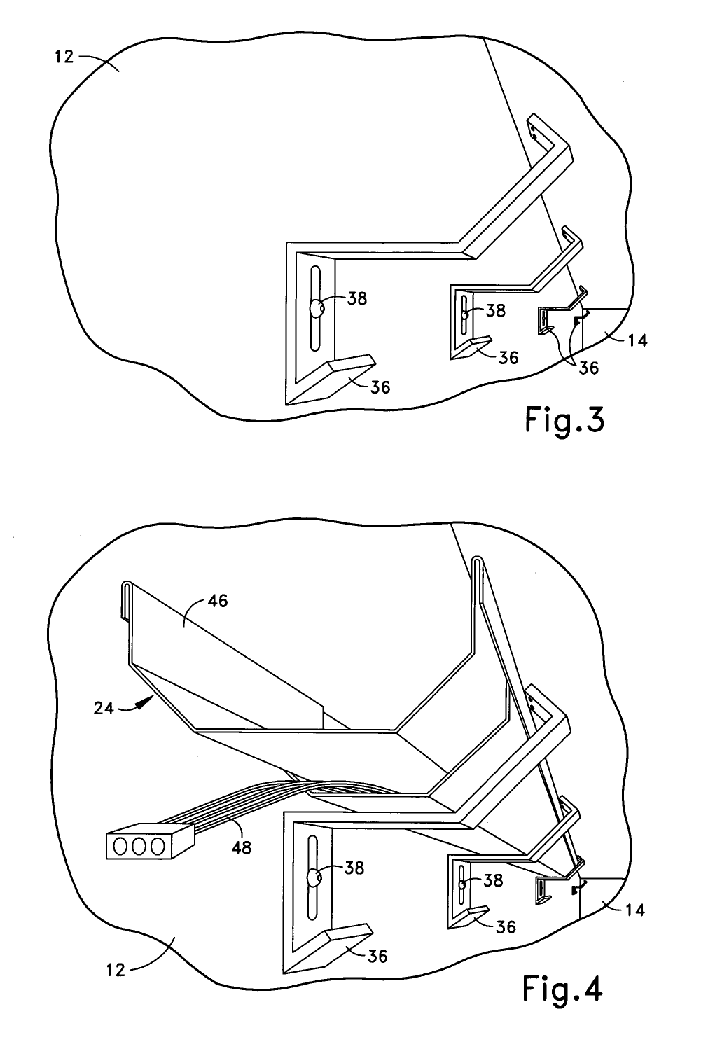

Turning to the first and second segments 22 and 26, the two segments have some amount of similarity. As such, only the first segment 22 is described in detail with an understanding the description is generally applicable to the second segment 26. The first segment 22 includes a plurality of attachment devices 36 (FIG. 3) that are used to secure the segment to the surface 12. It is to be appreciated that the attachment devices 36 may have any suitable configuration, construction, etc. for securing the segment 22 and supporting the other components of the segment and the associated light device 24. In the shown example, the attachment devices 36 are brackets. Each bracket is secured to the surface via a fastener 38 (e.g., a screw or the like).

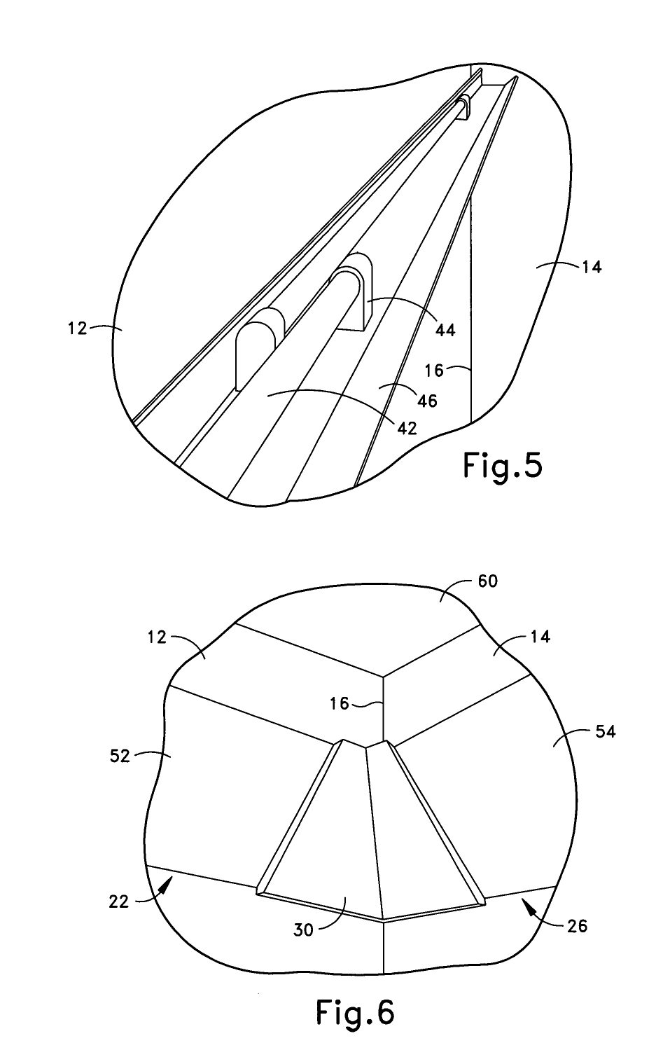

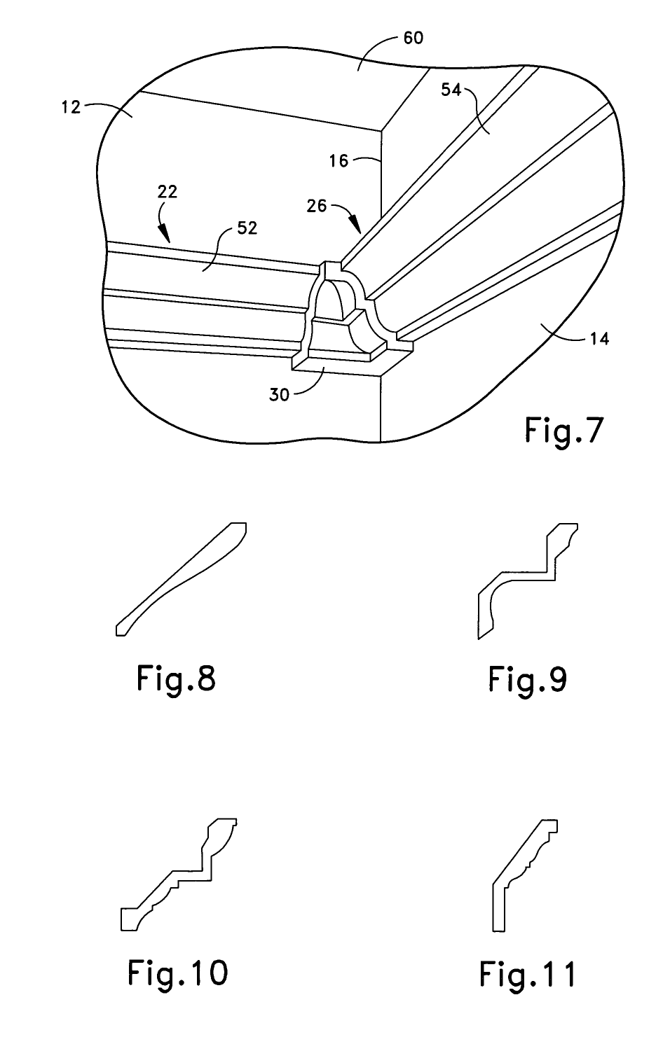

In the shown example, the light device 24 (FIG. 4, light producing elements are not visible) is supported on the attachment devices 36. It is to be appreciated that the light device 24 may be otherwise supported within the segment 22. It is also to be appreciated that the light device 24 may have any structure, configuration, etc. For example, the shown, example light device 24 (FIG. 5) has light tubes 42, electric connector supports 44, reflectors 46, and suitable electrical connections 48 (FIG. 4). Also, the light device 24 may be of any type (e.g., fluorescent, cold cathode, etc.). It is to be noted that although the reflectors 46 may have a variety of constructions, one suitable construction includes the use of Anolux Stucco Miro 9 available from Anomet Inc. of Brampton, Ontario Canada, ALANOD Inc. of Flushing, N.Y., both of which are part of the ALANOD GmbH & Co KG group.

In the shown example, only a single light device 24 is shown. It is to be appreciated that multiple light devices may be located on the segment 22, and the number of light devices may be related to the overall length of the segment. Still further, an adjustable light device may be employed as the light device or one of plural light devices. An example of an adjustable light device is disclosed in U.S. patent application Ser. No. 10/300,489, entitled “ADJUSTABLE-LENGTH LIGHT FIXTURE AND METHOD FOR INSTALLING SAME,” which is incorporated herein by reference. In short summary, within the adjustable light device the light tubes overlap each other, and yet are moveable relative to each other to change the overall length.

Turning back to the light mounting fixture 10 (FIG. 1), a cove piece 52 of the first segment 22 is mounted onto the attachment devices 36. The mounting of the cove piece 52 is accomplished via any suitable means such as interfitting parts on the attachment devices and the cove piece (e.g., snap-fit), mechanical fasteners, adhesive, or the like. The cove piece 52 extends along the extent of the first segment 22. In the shown example, the cove piece 52 is a unitary member. However, it is contemplated that the cove piece 52 could include plural members.

The cove piece 52 serves one or more functions. For example, the cove piece 52 can obscure the direct viewing of the other components of the first segment 22. In other words, the cove piece could prevent an observer from normal, direct viewing of the attachment devices 36, the light device 24, etc. Also, the cove piece 56 could provide protection from damage, elements, etc.

In the shown example, the cove piece 52 extends generally up from the bottom to the side of the first segment 22 that is distal from the adjacent wall 12. For such a configuration, light proceeding from the light device 24 is blocked from proceeding downwardly and is directed upwardly. However, it is contemplated that the cove piece 52 could have a different functional configuration. For example, the cove piece 52 could be open at a lower extent and/or the cove piece could extend to point above the first segment. Light would be permitted to proceed accordingly.

Also, it is to be appreciated that the cove piece 52 could be constructed of various materials. In one example, the cove piece 52 is made of aluminum. However, the cove piece 52 could be made of wood, plastic, etc. With regard to the use of plastic, it is contemplated that the plastic may have a level of translucence. This would permit a lower level of diffuse light to proceed through the cove piece 52.

It is to be appreciated that the light mounting fixture 10 can be positioned at any vertical location on the surfaces 12 and 14. In the shown example, the light mounting fixture 10 is located relatively near to a ceiling 60 (FIG. 7) and is relatively far from a floor 62 (FIG. 2).

As mentioned above, the second segment 26 has generally the same components (e.g., attachment devices), structures (e.g., light tubes, electrical connections, etc.) as the first segment. In particular, the second segment 26 has a cove piece 54. The cove pieces 52 and 54 have generally similar constructions, are attached in generally similar manners, etc.

The corner piece 30 (FIG. 2) typically has a complementary construction, configuration, etc. to the cover pieces 52 and 54 of the first and second segments 22 and 26. Thus, the combination of the cover pieces 52 and 54 and the corner piece 30 provides for an aesthetically pleasing appearance. This in itself is yet another function of the light mounting fixture 10. It is to be appreciated that the aesthetic aspects of the light mounting fixture 10 can be varied. For example, FIG. 7 shows the cover pieces 52 and 54 of the first and second segments 22 and 26, and the corner piece 30 of another embodiment. The example of FIG. 7 has a profile different from the profile of the previously described embodiment. FIGS. 8-11 show cross-sections of some additional profiles for the first and second segments and the corner piece. It is to be appreciated that many variations are possible and the shown examples are not limitations.

Another aspect of the present invention is directed to an installation methodology associated with the light mounting fixture 10. In short summary, the methodology of installing does not require a high level of precise measuring and pre-fabrication at an off-site location (e.g., a manufacturing facility). This is in distinction from other light mounting fixtures, which must be precisely fabricated or risk presenting a poor appearance. For the present invention, the two segments 22 and 26 need only be positioned such that the ends of the segments, and specifically the end of each cove piece 52, 54 need only extend to a point behind the corner piece 30. Also, it does not matter which of the first and second segments 22 and 26 extends closer to the corner intersection 16 of the two surfaces 12 and 14 because of the covering feature provided by the corner piece 30. As such, the sequence of attaching the segments 22 and 26 to the surfaces 12 and 14 can go in either order.

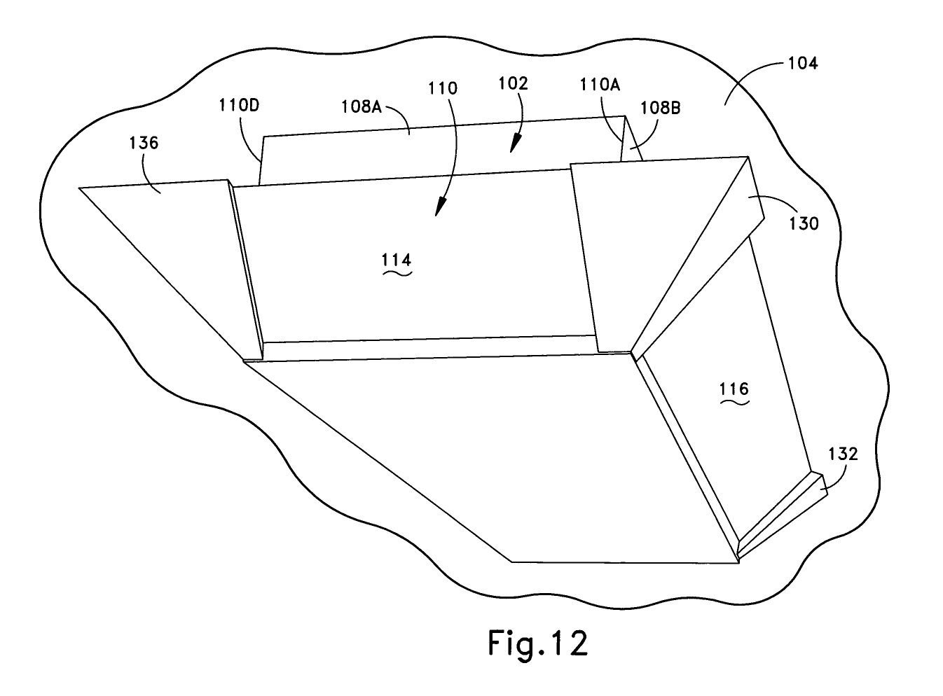

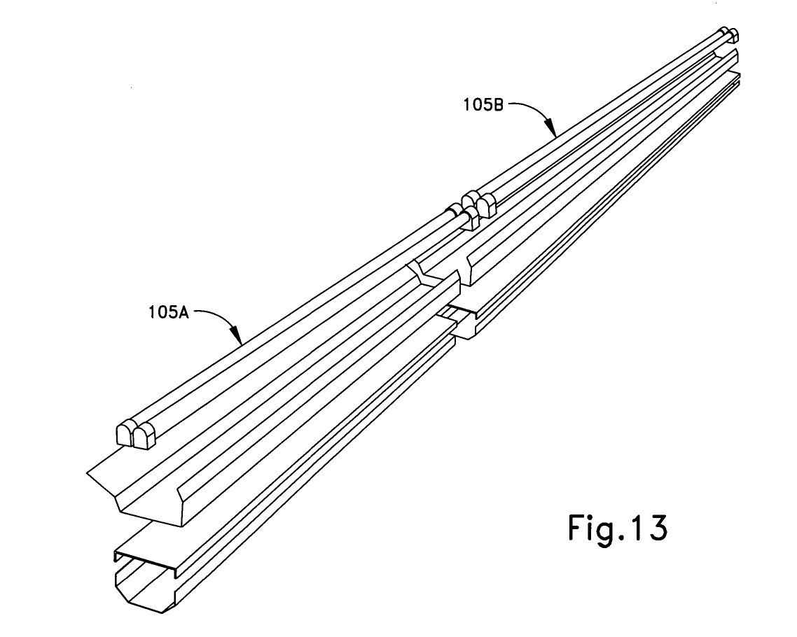

As mentioned above, the present invention can be utilized in other environments and is not limited to mere use on walls that intersect at an interior corner. For example, FIG. 12 shows a light mounting fixture 100 secured to an island 102 that extends downward from a ceiling 104. The island 102 has a plurality (e.g., four) surfaces (only two visible, 108A, 108B), with each adjacent pair of surfaces intersecting at an exterior corner (e.g., 110A). As such, the island has four exterior corners (only two visible, 110A, 110D).

The example fixture 100 has a corresponding number of (e.g., four) segments (only two visible, 114, 116), each extending along a respective surface (e.g., 108A, 108B). Each segment may have structure similar to the segments of the above-discussed embodiment, or may have slightly different structure. In general, the segments include mounting devices, fasteners, light tubes, a reflector, and a cove piece.

The example fixture 100 has a corresponding number (e.g., four) of corner pieces (only three visible, 130, 132, 136). Each corner piece (e.g., 130) covers end portions of two adjacent segments (e.g., 114 and 116). As such, each pair of the segments (e.g., 114 and 116) does not need to meet in a perfect mating arrangement at the respective corner (e.g. 110A). The corner pieces (e.g., 130, 132, 136) cover any mating imperfections.

As mentioned above, various modifications are possible within the scope of the present invention. One aspect that may have a variety of possible modifications is with regard to the light fixtures. FIG. 13 shows one example of such ability to modify the light fixture. Specifically, each lamp/lamp socket is a separate fixture (e.g., 150A or 150B). Longitudinally adjacent fixtures (i.e., lamps/lamp sockets) are butted end to end. It is to be noted that the longitudinally adjacent lamps/lamp sockets are in separate, longitudinally adjacent fixtures. Such a light fixture arrangement could be used in place of the light fixtures shown in FIG. 5.

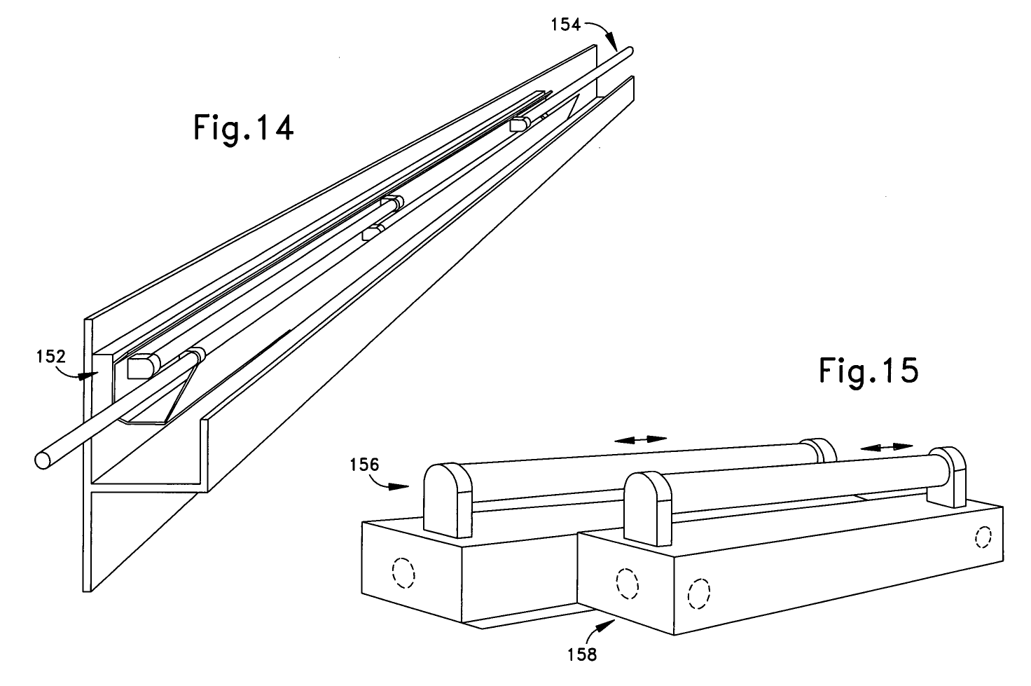

As another possibility, FIG. 14 shows lamps with sockets staggered on the backside 152 of the fixture. Within such an arrangement the lamps (e.g., fluorescent lamps) can also slide (side to side) on a backside of the fixture at the corner (e.g., at the area designated 154). It should be appreciated that adjustability is a beneficial aspect of the present invention.

Along the lines of adjustability, it should be appreciated that such adjustability may be achieved in a variety of ways. FIG. 15 shows an example embodiment in which adjustability is accomplished via adjustable fixtures. Specifically, FIG. 15 shows separate fixtures 156, 158, each containing one lamp, although multiple lamps are possible, and associated sockets. The fixtures 156, 158 are in a staggering configuration. These fixtures 156, 158 are adjustable (slidable, side to side one fixture relative to the other fixture) to eliminate socket shadows. The double-headed arrows in FIG. 15 indicate the relative sliding. The fixtures 156,158 also lock together. This staggering can be done along the entire wall or cove, or a designated area within the wall or cove area, or a fixture at the corner of the wall or cove.

It is to be noted that adjustable staggering helps prevent uneven light presentation. However, other aspects may also be used within the scope of the present invention to help prevent uneven light presentation.

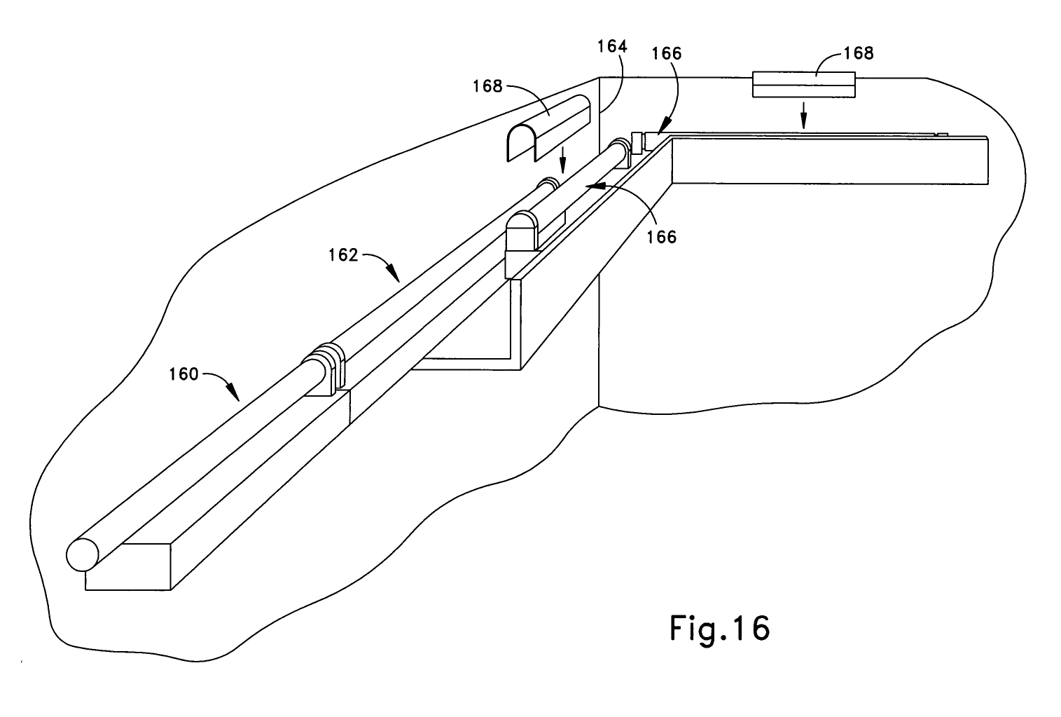

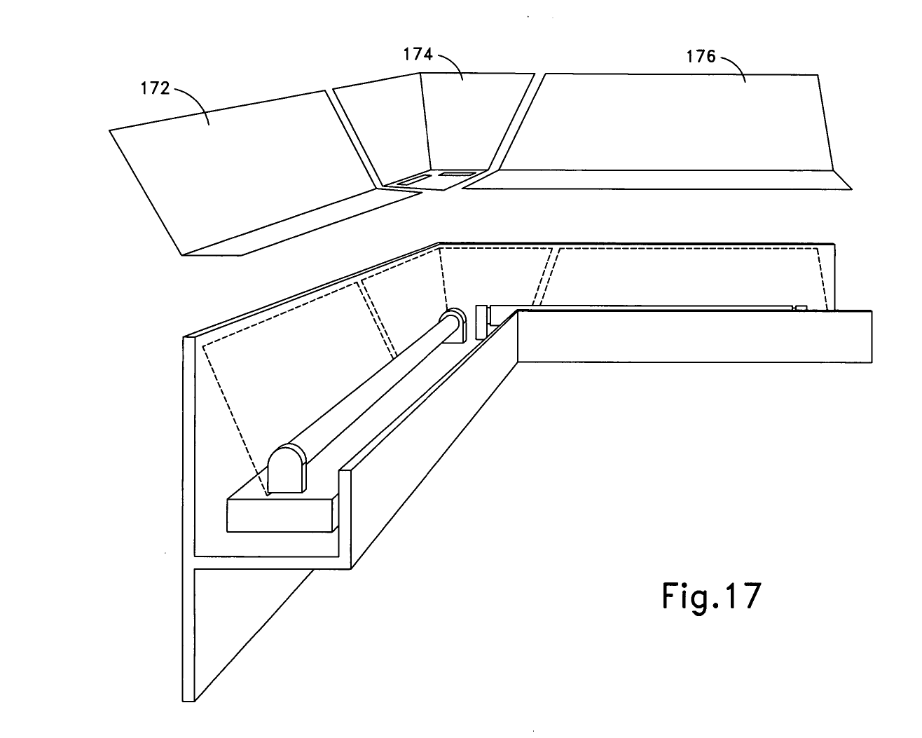

As one example of an aspect that helps prevent uneven light presentation, attention is directed to FIG. 16. Within the shown example, it can be seen that light fixtures 160, 162 that extend along a major extent of a wall are butted, end to end, longitudinally. However, at the area of a wall corner 164, a fixture 166 nearest to the corner is staggered in front of the last of the butted fixtures. A sliding cover 168 (opaque acrylic or metal) on top of the staggered fixture 166 at the portion of the fixture 166 which is staggered in front of the last butted fixture 162. The sliding cover 168 blocks out or eliminates extra illumination, due to the extra lamp in front of the butted fixture area. It is to be noted that the fixtures (e.g., 166) may also be configured to permit sliding for adjustment. In one specific example, a lamp (e.g., a fluorescent lamp) can slide (side to side) on top of the respective fixture. The relatively sliding lamp may be on the fixture at the corner or one of the butted fixtures. Also, more than one fixture may have a configuration to permit relative sliding of the lamp.

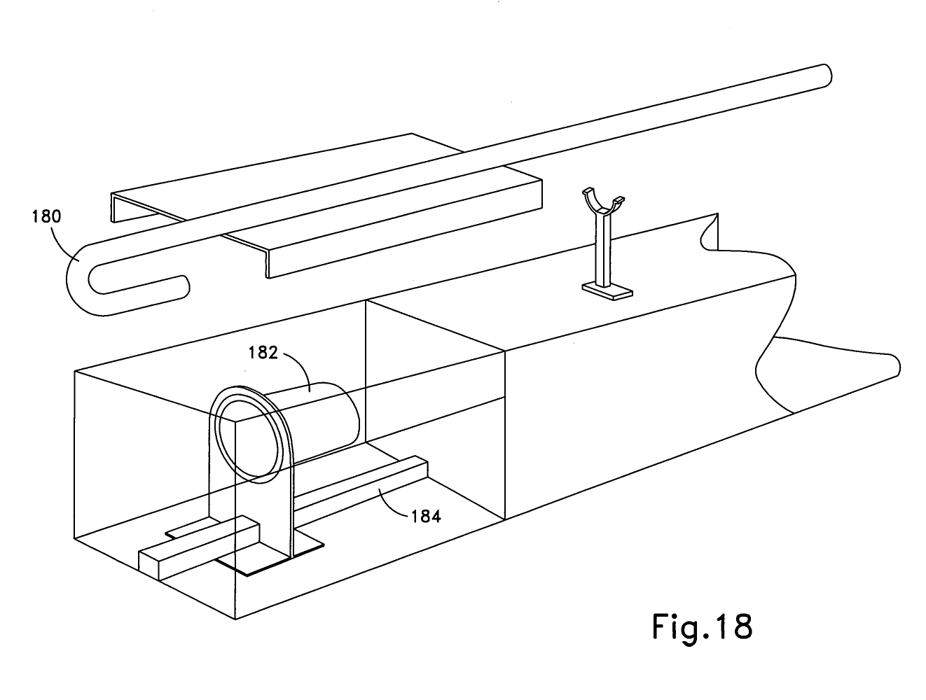

In accordance with another aspect, the present invention may include the use of one or more reflectors 172-176 within a light-mounting device. FIG. 17 shows an example of the use multiple reflectors. The reflectors 172-176 shown in the example are positioned at the area of a corner of a wall or cove to reflect light into the corner of the wall or cove to prevent shadows or direct light into the corner (the reflectors are shown exploded out, the final positions of the reflectors are shown in phantom). Specifically, within the shown example, three reflectors 172-176 are used. One reflector 174 is at the corner, and two other reflectors 172, 176 are adjacent on the two sides of the reflector at the corner. Within the aspect of using reflectors, it is to be noted that reflectors positioned along any segment of the wall/cove or along the entire wall/cove to reflect light onto the wall or cove to prevent shadows or direct light into a specified area of the wall. The reflectors can be colored to change the reflected white lamp or colored lamp to produce a different color in the corner of a wall or cove or across the entire length of the wall or cove.

Also with regard to the type of lamps, it is to be appreciated that a variety of lamps and associated structures are useable in accordance with one aspect of the present invention. FIG. 18 shows an example of such structure in accordance with one aspect of the present invention. The shown example structure is for use with a cold cathode or neon lamp 180. A sliding lamp socket housing 182 enables installation or removable of the cold cathode or neon lamp in a fixture. The fixture includes a fixed guide portion 184 along which the socket 182 may slide along the longitudinal directions of the light fixture. The socket 182 can thus engage/disengage a terminus portion of the lamp. In the shown example, the lamp 180 has a U-shaped end portion to mate with the socket, which faces outboard of the longitudinal ends of the light fixture.

From the above description of the invention, those skilled in the art will perceive improvements, changes and modifications. Such improvements, changes and modifications within the skill of the art are intended to be covered by the appended claims.

1. A light mounting fixture for first and second surfaces that intersect at a corner, the light mounting fixture including:
a plurality of attachment devices for connection to the two surfaces;
a first cove piece for connection to a first group of the attachment devices, for extending along a segment of the first surface, and for receiving at least one lighting device therein;
a second cove piece for connection to a second group of the attachment devices, for extending along a segment of the second surface, and for receiving at least one lighting device therein, the first and second cove pieces each having ends for location in the vicinity of intersection of the surfaces at the corner with the ends being located in a non-fitted manner with respect to at least one of the surfaces or each other; and
a corner piece for overlapping a least a portion of each of the first and second cove pieces and for obscuring from view the ends of the first and second cove pieces and the non-fitted manner of location of the ends.

2. A light mounting fixture as set forth in claim 1, wherein the non-fitted manner of the end pieces includes at least one of the ends of the first and second cove pieces being spaced away from the surface associated with the other of the first and second cove pieces.

3. A light mounting fixture as set forth in claim 1, wherein the non-fitted manner of the end pieces includes at least one of the ends of the first and second cove pieces being spaced away from the other of the first and second cove pieces.

4. A light mounting fixture as set forth in claim 1, wherein the non-fitted manner of the end pieces includes one of the first and second cove pieces extending to have its end face the surface associated with the other of the first and second cove pieces, and the other of the first and second cove pieces extending to face the one of the first and second surfaces.

5. A light mounting fixture as set forth in claim 1, wherein intersection of the surfaces is an interior corner, and wherein the corner piece is configured to mate with the interior corner.

6. A light mounting fixture as set forth in claim 1, wherein intersection of the surfaces is an exterior corner, and wherein the corner piece is configured to mate with the exterior corner.

7. A light mounting fixture as set forth in claim 1, wherein the lighting device of at least one of the first and second cove pieces includes structure to permit length adjustment.

8. A light mounting fixture as set forth in claim 7, wherein the lighting devices of each of the first and second cove pieces include structure to permit length adjustment.

9. A light mounting fixture as set forth in claim 1, wherein at least one of the first and second cove pieces is configured for receiving a plurality of lighting devices therein.

10. A light mounting fixture as set forth in claim 9, wherein the plurality of lighting devices includes lighting devices that are abutted end to end.

11. A light mounting fixture as set forth in claim 9, wherein the plurality of lighting devices includes lighting devices that overlap each other.

12. A light mounting fixture as set forth in claim 11, wherein at least one of the plurality of lighting devices is slidably adjustable.

13. A light mounting fixture as set forth in claim 9, wherein the at least one of the first and second cove pieces is configured for receiving a cover for extending over a portion of the at least one of the plurality of lighting devices.

14. A light mounting fixture as set forth in claim 9, wherein the at least one of the first and second cove pieces is configured for receiving a reflector for directing light.

15. A light mounting fixture as set forth in claim 9, wherein the at least one of the first and second cove pieces includes at least one sliding lamp socket.

16. A light mounting fixture for first and second surfaces that intersect at a corner, the light mounting fixture including:
a plurality of attachment devices for connection to the two surfaces;
a first cove piece for connection to a first group of the attachment devices, for extending along a segment of the first surface, and for receiving at least one lighting device therein;
a second cove piece for connection to a second group of the attachment devices, for extending along a segment of the second surface, and for receiving at least one lighting device therein, the first and second cove pieces each having ends for location in the vicinity of intersection of the surfaces at the corner with at least one of the ends of the first and second cove pieces being spaced away from the surface associated with the other of the first and second cove pieces or being spaced away from the other of the first and second cove pieces; and
a corner piece for overlapping a least a portion of each of the first and second cove pieces and for obscuring from view the ends of the first and second cove pieces and any spacing of the ends away from the surfaces and each other.

17. A light mounting fixture as set forth in claim 16, wherein the end of the first cove piece faces and is spaced away from the surface associated with the second cove piece and the end of the second cove piece faces and is spaced away from the first cove piece.

18. A light mounting fixture as set forth in claim 16, wherein intersection of the surfaces is an interior corner, and wherein the corner piece is configured to mate with the interior corner.

19. A light mounting fixture as set forth in claim 16, wherein the lighting device of the first cove piece includes structure to permit length adjustment.

20. A light mounting fixture as set forth in claim 19, wherein the lighting device of the second cove piece includes structure to permit length adjustment.

21. A light mounting fixture as set forth in claim 16, at least one of the first and second cove pieces is configured for receiving a plurality of lighting devices therein.

22. A light mounting fixture as set forth in claim 21, wherein the plurality of lighting devices includes lighting devices that are abutted end to end.

23. A light mounting fixture as set forth in claim 21, wherein the plurality of lighting devices includes lighting devices that overlap each other.

24. A light mounting fixture as set forth in claim 23, wherein at least one of the plurality of lighting devices is slidably adjustable.

25. A light mounting fixture as set forth in claim 21, wherein the at least one of the first and second cove pieces is configured for receiving a cover for extending over a portion of the at least one of the plurality of lighting devices.

26. A light mounting fixture as set forth in claim 21, wherein the at least one of the first and second cove pieces is configured for receiving a reflector for directing light.

27. A light mounting fixture as set forth in claim 21, wherein the at least one of the first and second cove pieces includes at least one sliding lamp socket.

28. A light mounting fixture including:
means for attaching the fixture to a surface;
a cove piece for connection to the means for attaching and extending along a segment of the surface; and
a lighting device received within the cove piece;
the lighting device including a lamp and at least one sliding lamp socket for receiving an end of the lamp.

29. A light mounting fixture as set forth in claim 28, wherein the surface is a first surface and a second surface intersects with the first surface at a corner, the means for attaching includes a plurality of attachment devices for connection to the first and second surfaces, the cove piece is a first cove piece and is for connection to a first group of the attachment devices, the fixture includes a second cove piece for connection to a second group of the attachment devices, and for extending along a segment of the second surface, the fixture includes at least another lighting device received within the second cove piece, the first and second cove pieces each have ends for location in the vicinity of intersection of the surfaces at the corner with the ends being located in a non-fitted manner with respect to at least one of the surfaces or each other; and the fixture including a corner piece for overlapping a least a portion of each of the first and second cove pieces and for obscuring from view the ends of the first and second cove pieces and the non-fitted manner of location of the ends.

30. A method of installing a light mounting fixture on first and second surfaces that intersect at a corner, the method including:
connecting a plurality of attachment devices to the two surfaces;
connecting a first cove piece, which receives at least one lighting device therein, to a first group of the attachment devices such that the first cove piece extends along a segment of the first surface;
connecting a second cove piece, which receives at least one lighting device therein, to a second group of the attachment devices such that the second cove piece extends along a segment of the second surface, wherein the steps of connecting the first and second cove pieces include positioning at least one of the first and second cove pieces such that at least one of the ends of the first and second pieces location in the vicinity of intersection of the surfaces at the corner are located in a non-fitted manner with respect to at least one of the surfaces or each other;
overlapping a corner piece over a least a portion of each of the first and second cove pieces to obscure from view the ends of the first and second cove pieces and the non-fitted manner of location of the ends.

31. A method of installing a light mounting fixture as set forth in claim 30, wherein the step of positioning at least one of the first and second cove pieces is such that the non-fitted manner of the end pieces includes at least one of the ends of the first and second cove pieces being spaced away from the surface associated with the other of the first and second cove pieces.

32. A method of installing a light mounting fixture as set forth in claim 30, wherein the step of positioning at least one of the first and second cove pieces is such that the non-fitted manner of the end pieces includes at least one of the ends of the first and second cove pieces being spaced away from the other of the first and second cove pieces.

33. A method of installing a light mounting fixture as set forth in claim 30, wherein the step of positioning at least one of the first and second cove pieces is such that the non-fitted manner of the end pieces includes one of the first and second cove pieces extending to have its end face the surface associated with the other of the first and second cove pieces, and the other of the first and second cove pieces extending to face the one of the first and second surface.

34. A method of installing a light mounting fixture as set forth in claim 30, wherein intersection of the surfaces is an interior corner, and the step of overlapping the corner piece includes mating the corner piece with the interior corner.

35. A method of installing a light mounting fixture as set forth in claim 30, including adjusting a length of a lighting device for at least one of the first and second cove pieces.

36. A method of installing a light mounting fixture as set forth in claim 30, including adjusting a length of a lighting device for each of the first and second cove pieces.
